(19) United States
(12) Patent Application Publication
(10) Pub. No.: US 2026/0258887 A1
(43) Pub. Date: Sep. 3, 2026

(54) ARRANGEMENT FOR TRANSPORTING MEDIA

(71) Applicant: TI Automotive Technology Center GmbH, Rastatt (DE)

(72) Inventors: Albert BOECKER, Rastatt (DE); Thorsten SCHAEFER, Steinfeld (DE); Florian DEIBEL, Sinzheim (DE); Matthias WINTER, Karlsruhe (DE)

(21) Appl. No.: 19/141,414

(22) PCT Filed: Dec. 13, 2023
(86) PCT No.: PCT/EP2023/085579

§ 371 Date: Jun. 20, 2025

(30) Foreign Application Priority Data
Dec. 20, 2022 (DE) 20 2022 107 087.3

(51) Int. Cl. F16L 9/22; F16L 9/12

(52) U.S. Cl. CPC F16L 9/22; F16L 9/12

(57) ABSTRACT

An arrangement for transporting media including a base body designed as a blow-molded part and at least one functional element which is fixed to the base body. The base body and the functional element each include at least one flow channel, and the base body has openings and the flow channels of the base body and the functional element are connected in a flow-conducting manner via the openings. The base body and the functional element are connected to one another in a media-tight manner by at least one materially bond encompassing the openings.

### RELATED APPLICATIONS

The present disclosure claims priority to and is a national phase application of PCT Application PCT/EP2023/085579, filed Dec. 13, 2023, the entire contents of which are incorporated herein by reference.

### FIELD

The present disclosure relates to an arrangement for transporting media having a base body designed as a blow-molded part and at least one functional element which is fixed to the base body.

### BACKGROUND

Such media transport arrangements are used, for example, in electric vehicles and serve to transport temperature control medium toward the components of the electric vehicle in order to heat or cool them as required. For this purpose, the drive unit of an electric vehicle can be equipped with a temperature control circuit with a pipe arrangement through which a temperature control medium can be fed to the cells of the battery in order to control the temperature of the components of the drive unit, in particular the batteries, within a desired temperature spectrum. In addition to the batteries, other components whose temperature needs to be controlled can include the power electronics and the electric motor. In connection with fast charging processes, temperature control of the charging electronics and the associated plug connections and cables can also be considered. A need may also arise in the area of other vehicle electronics, such as the sensors and on-board computers that can be equipped for autonomous driving.

In order to form a compact and inexpensive arrangement for transporting media, it is known to integrate functional elements directly into the base body, which is formed as a blow-molded part. If there is a flow-conducting connection between the base body and the functional element, problems arise with regard to a permanently tight connection between the base body and the functional element.

### SUMMARY

The present disclosure provides an arrangement for transporting media which can be manufactured simply and inexpensively.

The arrangement for transporting media according to the present disclosure comprises a base body designed as a blow-molded part and at least one functional element which is fixed to the base body, wherein the base body and the functional element each comprise at least one flow channel, and wherein the base body comprises openings and wherein the flow channels of the base body and the functional element are connected in a flow-conducting manner via the openings, wherein the base body and the functional element are connected to one another in a media-tight manner by at least one materially bond encompassing the openings.

The base body and the functional element are connected to each other firmly and in a media-tight manner by the materially bond that encompasses the openings. It is particularly advantageous that the media-tight connection can be made easily and inexpensively. In particular, it is possible to create the materially bond while molding the base body by the blow molding process. In doing so, it is not necessary to arrange additional sealing elements, such as flat gaskets or O-rings, between the base body and the functional element.

Preferably, the materially bond between the base body and the functional element is formed while molding the base body by blow molding. Therefore, there is no need for additional manufacturing steps to produce a media-tight (e.g. fluid tight or fluid sealed) connection between the base body and the functional element. Depending on how the blow molding process is carried out, a region of the base body defining the opening may be covered by a section of the preform forming the base body after the molding of the base body has been completed and the materially bond between the base body and the functional element has been created. Therefore, it may be necessary to remove the material of the preform in the area of the opening in a subsequent manufacturing step. For this purpose, a bore can be made in the base body to create the opening, or the wall of the base body can be cut out in the area of the opening.

In principle, it is conceivable that the base body is connected to several functional elements, wherein each functional element is in flow connection with the base body via a separate opening. Another embodiment provides that several openings are provided between the base body and the functional element.

The base body and the functional element can be form-fittingly locked to each other. The form-fitting connection results in better mechanical load-bearing capacity and, in particular, the materially bond between the base body and the functional element, which ensures the media-tight connection between the two components, is relieved of mechanical force effects by the additional form-fitting connection.

Preferably, the base body and the functional element are formed of plastic. This allows providing an arrangement that is inexpensive and easy to manufacture. In doing so, the base body is designed as a blow-molded part. The functional element can also be designed as a blow-molded element. Alternatively, it is also conceivable to manufacture the functional element by injection molding.

Preferably, at least one sealing contour encompassing the opening is formed from the functional element. The sealing contour preferably extends beyond the surface of the functional element and points in the direction of the base body. During manufacture, and in particular during molding of the base body, the wall of the base body rests against the functional element, and the protruding sealing contour ensures that there is linear contact between the base body and the functional element.

The sealing contour can be formed in a triangular or semicircular manner when viewed in section. Also conceivable are web-shaped or trapezoidal embodiments of the sealing contour. Preferably, the sealing contour is formed in an annular manner. This is particularly advantageous for circular openings. The shape of the opening depends on the available installation space and the volume flow to be passed through. Accordingly, openings with an irregular contour are also conceivable. In this case, it is advantageous if the sealing contour extends parallel to the contour bounding the opening. According to another advantageous embodiment, several sealing contours are provided which are arranged concentrically. The sealing contours can be spaced apart from the edge defining the opening.

The base body and the functional element can be joined by a materially bond along the sealing contours. In particular, in case of sealing contours protruding above the surface of the functional element, the sealing contour comes into contact with the functional element along the sealing contour during the molding of the base body by blow molding. In doing so, the material melts, preferably in the area of the sealing contour, and a media-tight materially bond is formed between the base body and the functional element.

A simple and inexpensive manufacturability of a materially bond between the functional element and the base body is given in particular if the base body and the functional element are made of plastic, wherein the plastic of the base body and the plastic of the functional element preferably have a similar melting temperature.

Polypropylene and/or polyamide are particularly suitable plastics for the base body and the functional element. It is also conceivable to form the base body and the functional element in multiple layers, wherein different plastics are used for the layers.

### BRIEF DESCRIPTION OF THE DRAWINGS

Some embodiments of the arrangement according to the present disclosure are explained in more detail below with reference to the figures. These show, each schematically:

FIG. 1 an arrangement in plan view;

FIG. 2 the arrangement in the exploded view;

FIG. 3 the arrangement in the area of the recesses in detail;

FIG. 4 the functional element with opening and sealing contours in detail.

### DETAILED DESCRIPTION

The figures show an arrangement 1 for transporting media. In the present embodiment, the arrangement 1 is a distribution structure that forms part of a temperature control circuit of an electric vehicle. The arrangement 1 is used for the transport and distribution of temperature control media, for example coolant in form of cooling water. Accordingly, the arrangement 1 serves to transport coolant to the electric vehicle components whose temperature needs to be controlled. Such components are, for example, the batteries, the electric motors and the power electronics.

The arrangement 1 comprises a base body 2 designed as a blow-molded part and two functional elements 3, which are form-fittingly fixed to the base body 2.

The base body 2 and the functional elements 3 are formed of plastic, according to a first embodiment of a polyolefin, for example polypropylene or a polyethylene (PE, HDPE) and according to a second embodiment of polyamide. The polyamide may be in form of PA 6, PA 6.10, PA 6.12, PA 10.10, PA 11 or PA 12. In case of PA 11 and PA 10.10, it is particularly advantageous that they are bio-based and manufactured on the basis of renewable raw materials. In another embodiment, the plastic of base body 2 and functional elements 3 comprises recycled material. Preferably, the proportion of recycled material is 30%.

Accordingly, the functional elements 3 are formed from injection-moldable plastic, wherein the plastics of the base body 2 and functional elements 3 are selected, so that they have similar melting temperatures. For polypropylene, the melting temperature is about 160° C., and for polyamide, the melting temperature is about between 190° C. and 230° C., depending on the embodiment.

In the present embodiment, the functional elements 3 form part of a pump, specifically a pump cover. In alternative embodiments, however, the functional elements 3 can also be formed as a cooler, sensor, valve, hose adapter or as a component of the aforementioned elements. In another alternative embodiment, the functional element 3 can also be formed as an adapter plate, wherein the adapter plate serves to accommodate further functional elements, for example sensors, pumps and/or valves.

The base body 2 and the functional elements 3 each comprise a flow channel 4, wherein the base body 2 comprises openings 5 and wherein the flow channels 4 of the base body 2 and the functional elements 3 are connected in a flow-conducting manner via the openings 5.

The base body 2 and the functional elements 3 are connected to one another in a media-tight manner by a materially bond encompassing the openings 5. In this case, the materially bond between the base body 2 and the functional elements 3 is formed by molding the base body 2 during blow molding. Several sealing contours 6 encompassing the openings 5 are formed from the functional elements 3.

To manufacture the arrangement, the functional elements 3 and a preform consisting of polymeric material are first provided and arranged in a blow mold. The base body 2 is then formed from the preform by blow molding, wherein the preform comes to rest against the functional elements 3 during the forming process. In doing so, the preform contacts the sealing contours 6.

The sealing contours 6 extend beyond the surface of the functional elements 3 and are formed in a rib-shaped manner in the present embodiment. In the present embodiment, the functional elements 3 are provided with three annular sealing contours 6 arranged concentrically around the openings 5. The sealing contours 6 have a triangular shape in cross-section.

Due to the shape of the sealing contours 6, heat dissipation through the sealing contours 6 is limited, so that they melt as soon as the preform of the base body 2 touches the surface of the functional elements 3 and thus the sealing contours 6. The melting of the sealing contours 6 in turn produces a media-tight materially bond between the functional elements 3 and the base body 2 in the area of the openings 5. After completion of the blow molding process, the base body 2 and the functional elements 3 are connected along the sealing contours 6 in a media-tight manner by a materially bond.

To improve the mechanical load capacity, the functional elements 3 are also form-fittingly fixed to the base body 2. In this case, the form-fit is formed by reshaping the preform to the base body 2 during blow molding.

The functional elements 3 have recesses 7, wherein the recesses 7 each form an undercut. The base body 2 extends into the recesses 7 to form the form-fitting connection. In doing so, projections 8 are formed from the base body 2, the projections projecting into the recesses 7. The free ends of the projections 8 expand like mushroom heads, so that a form-fitting connection is formed between the base body 2 and the functional element 3.

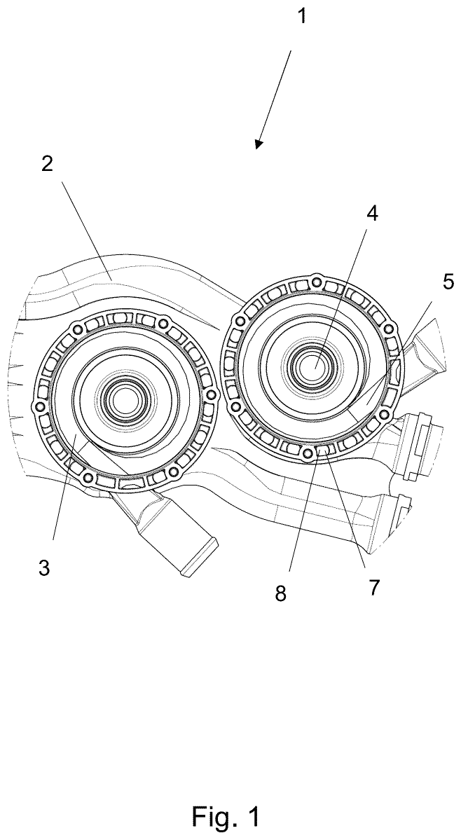

FIG. 1 shows the arrangement 1 in plan view. The two functional elements 3, each forming a pump cover, have an essentially circular basic shape. The recesses 7 are distributed around the circumference in the edge area of the functional elements 3. Projections 8 formed congruently to the recesses 7 are formed from the base body 2, wherein the projections 8 extend into the recesses 7.

The base body 2 comprises openings 5 and the flow channels 4 of the base body 2 and the functional elements 3 are connected in a flow-conducting manner via the openings 5.

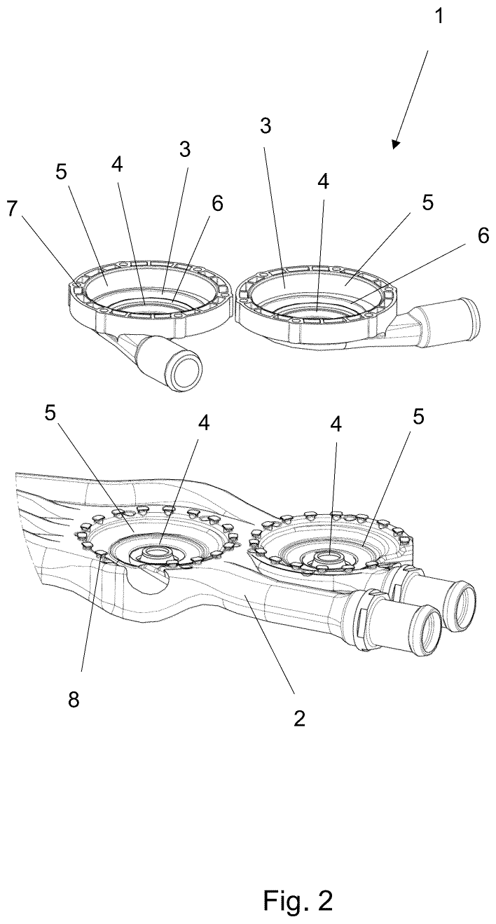

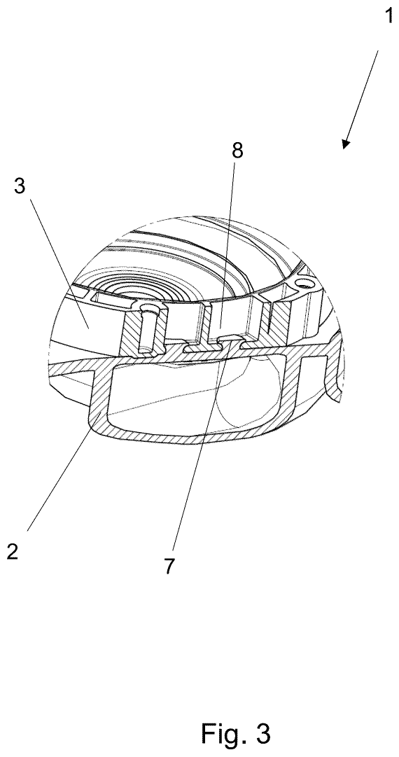

FIG. 2 shows the arrangement 1 shown in FIG. 1 in the exploded view. It can be seen that the base body 2 is shaped congruently to the functional elements 3 in the area of the functional elements 3, which enables a particularly space-saving integration of the functional elements 3 in the base body 2. FIG. 3 shows, in detail and in section, the arrangement 1 in the area of the recesses 7.

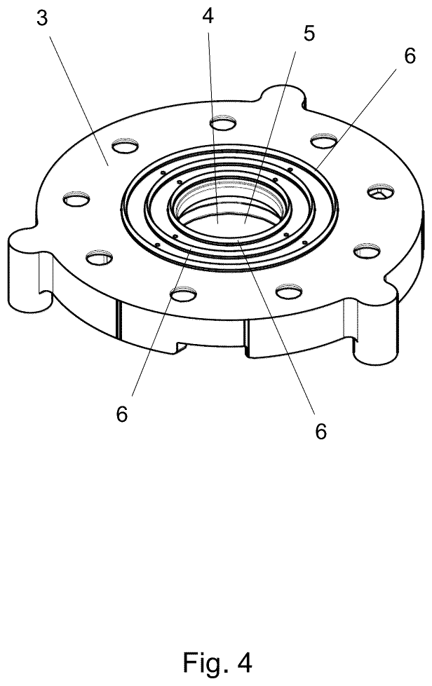

FIG. 4 shows a functional element 3 in detail before the joining process. In this case, three annular sealing contours 6 concentrically surrounding the opening 5 can be seen, which have a triangular shape in section. The sealing contours 6 melt during the blow molding process and the associated molding of the base body 2, and the functional element 3 connects to the base body 2 along the sealing contours 6 in a media-tight manner with a materially bond.

1. An arrangement for transporting media, comprising a base body designed configured as a blow-molded part and at least one functional element which is fixed to the base body, wherein the base body and the functional element each comprise at least one flow channel, and wherein the base body comprises includes openings and wherein the flow channels of the base body and the functional element are connected in a flow-conducting manner via the openings, and wherein the base body and the functional element are connected to one another in a media-tight manner by at least one materially bond encompassing the openings.

2. The arrangements according to claim 1, wherein the connection between the base body and the functional element is formed while molding the base body by blow molding.

3. The arrangement according to claim 1, wherein the base body and the functional element are form-fittingly locked to each other.

4. The arrangement according to claim 1, wherein the base body and the functional element are formed of plastic.

5. The arrangement according to claim 1, wherein at least one sealing contour encompassing the opening is formed from the functional element.

6. The arrangement according to claim 5, characterized wherein the base body and the functional element are connected along the sealing contour by a materially bond.

7. The arrangement according to claim 5, wherein the sealing contour is formed in an annular manner.

8. The arrangement according to claim 5, characterized wherein several concentrically arranged sealing contours are provided.

9. The arrangement according to claim 1, wherein the material of base body and the material of the functional element have a similar melting temperature.

10. The arrangement according to claim 1, wherein the base body and/or the functional element are formed from a polyolefin or a polyamide.
